(19) United States
(12) Patent Application Publication
(10) Pub. No.: US 2009/0095153 A1
(43) Pub. Date: Apr. 16, 2009

(54) NATURAL GAS RECOVERY SYSTEM AND METHOD

(76) Inventors: Paul Roper, Rock Springs, WY (US); John Fredrickson, LaBarge, WY (US)

Correspondence Address: MORRISS OBRYANT COMPAGNI, P.C., 734 EAST 200 SOUTH, SALT LAKE CITY, UT, 84102, US

(21) Appl. No.: 11/871,715

(22) Filed: Oct. 12, 2007

(51) Int. Cl. B01D 53/30

(52) U.S. Cl. 95/11; 96/399; 96/400

(57) ABSTRACT

The present invention is a method and system for recovering natural gas used to operate a diaphragm pump in a gas production unit (GPU) at or near a natural gas well. A system embodiment may include a back pressure valve installed on a natural gas line between an exhaust port of heat trace diaphragm pump and a vent to atmosphere, the back pressure valve configured for selectively blocking flow of natural gas to the vent. The system may further include a return line connected between the natural gas line and a burner system fuel line for redirecting the natural gas to a burner system. An embodiment of a method of recovering natural gas expelled from a heat trace diaphragm pump exhaust port may include preventing the natural gas from exhausting to atmosphere and redirecting the natural gas to a natural gas supply system.

### BACKGROUND OF THE INVENTION

1. Field of the Invention

This invention relates generally to equipment used in the oil and gas industry. More particularly, the invention relates to a method and system for recovering natural gas.

2. Description of Related Art

Natural gas and oil may be obtained from oil and/or natural gas wells using a gas production unit (GPU). A GPU is typically located in the field near one or more oil and/or natural gas wells. A GPU generally includes a bath section and a separator section. A GPU may have a heat trace pump used to warm saturated natural gas, oil and water entering a bath section from a well in order to prevent freezing of the pipelines used to process the natural gas, oil and water in the separator section. A heat trace pump is typically a pneumatic diaphragm pump that requires a source of pressurized gas to operate. The pressurized gas acts upon the diaphragm in a heat trace pump to move a piston back and forth. The action of the piston provides the pumping action that pushes antifreeze fluid though a piping system (sometimes referred to as heat trace lines) surrounding the dump lines exiting the separator section. While pressurized air is generally preferred for operating such diaphragm pumps, pressurized natural gas will suffice and is, in fact, commonly used to run a diaphragm pump in the field because it is readily available from the GPU separator or dehydrator or from a natural gas supply system. The natural gas used to operate the diaphragm pump is not burned during use and is conventionally just vented to atmosphere.

FIG. 1 is a simplified block diagram of conventional GPU 100. A typical GPU 100 may include a bath section 102 and a separator section 104. One purpose of the bath section 102 is to elevate the temperature of the saturated gas 106 coming from the well to avoid freezing and flow restriction during processing during operation in cold temperatures. The bath section 102 typically includes a contained volume of antifreeze fluid surrounding a pipe coil system (neither shown for clarity). Saturated gas 106 from the well 108 flows through the pipe coil system (not shown) and is heated if necessary by the surrounding antifreeze fluid in the bath section 102. Heated saturated gas 106A is output from the bath section 102 and into the separator section 104 of GPU 100. While the term “heated” saturated gas 106A is used herein, it will be understood that “heated” saturated gas 106A may be at any suitable temperature sufficient for further processing and to avoid being in a solid state. The antifreeze fluid in the bath section 102 is generally kept in a range from about 100° F. to about 150° F.

In the separator section 104, the heated saturated gas 106A is divided into three separate streams: natural gas 110, oil 112 and water 114. The natural gas stream 110 passes through the separator section 104 and into the natural gas pipeline system 116 to be sold as pipeline quality natural gas. Processing of the heated saturated gas 106A in the separator section 104 may be at pressures up to 1000 psi. The separated oil and water are initially contained in separate compartments 118 and 120, respectively, in a separator vessel, shown generally at 122. Both the oil and water compartments 118 and 120 contain floats (not shown for clarity). When the liquid level in either the oil or water compartment 118 and 120 rises to a predetermined float height, a control valve (also not shown for clarity) is activated, sending the oil 112 or water 114 to separate oil and water storage tanks 124 and 126 at a suitable distance from the GPU 100. The oil 112 and water 114 pipelines running from the oil and water compartments 118 and 120 out to the storage tanks 124 and 126 are also referred to as “dump lines.”

FIG. 2 is a simplified diagram of a conventional natural gas fuel system 200 for use with a conventional GPU 100 (FIG. 1). The bath section temperature is controlled by a burner system 202 fed with natural gas 207 from a natural gas supply 206. The natural gas supply 206 may in turn be supplied from a natural gas pipeline system 116 (see FIG. 1). Alternatively as shown in FIG. 2, natural gas supply 206 may be fed by natural gas line 110 from the separator section 104 (see FIG. 1) of a GPU 100 (see FIG. 1), which may be regulated by a regulator 222 before piping 205 into the natural gas supply 206. In yet another embodiment (not illustrated), the natural gas supply 206 may be from any other suitable source of pressurized natural gas. The burner system 202 contains two burners: a pilot burner 208 and a main burner 210 used to heat the bath section 102 antifreeze fluid (not shown for clarity). When the burner system 202 is in use, the pilot burner 208 is continuously lit. The main burner 210 is controlled by a thermostat 204 in communication with a motor valve 212 on the regulated natural gas line 214 in order to maintain the desired temperature of the bath section 102 antifreeze fluid.

Burner system 202 may include a pressure regulator 222 for reducing the pressure of the natural gas from the natural gas supply 206. The high pressure natural gas supply 206 may be pressurized, for example and not by way of limitation, in a range of about 60 psi to about 80 psi. The burner system 202 pressure regulator 222 reduces (regulates) the pressure of the natural gas to a range of about 6 psi to about 15 psi for use in the burner system 202 at regulated natural gas line 214. Another pressure regulator 222 may also be used to reduce the pressure of the natural gas used to drive the heat trace pump 218. The pressure reducing regulator 222 for the heat trace pump 218 provides pressurized natural gas 224 in a range from about 10 psi to about 15 psi for driving the pneumatic diaphragm heat trace pump 218. The particular pressure of natural gas may be selectively changed to vary the speed of the heat trace pump 218. It will be understood that various alternative means for regulating the pressure of the natural gas used in the burner system 202 or for driving the heat trace pump 218 will be readily apparent to one of skill in the art. Such alternative means are considered to be within the scope of the present invention.

The bath section 102 antifreeze fluid is heated by the burner system 202 to a range of about 100° F. to about 150° F. The heated antifreeze fluid flows from the bath section 102 to an inlet port 216 of a heat trace pump 218 where it is pumped out of outlet port 220 to a heat trace piping system (not shown) that parallels the dump lines 112 and 114 (FIG. 1) to prevent the dump lines 112 and 114 (FIG. 1) from freezing when the ambient temperature is sufficiently cold, for example in winter months. When freezing of the dump lines 112 and 114 (FIG. 1) and saturated gas 106 in the bath section 102 is not a concern, for example in summer months, the heat trace pump 218 may be turned off.

The heat trace pump 218 used in the field at a GPU 100 (FIG. 1) may be a pneumatic-powered diaphragm pump. A SANDPIPER® Model S1F air-powered double-diaphragm pump available from Warren Rupp, Inc., Mansfield, Ohio, is an exemplary pneumatic-powered diaphragm pump for use as a heat trace pump 218. It will be understood that there are many such diaphragm pumps available from other manufacturers suitable for use as a heat trace pump 218. While such pneumatic-powered diaphragm pumps are typically designed to be powered by compressed air, in practice, any compressed gas including natural gas, may be used.

It is possible to use a compressor to obtain compressed air for running a pneumatic-powered diaphragm pump. However, using compressed air may require a compressor (not shown) and electricity (not shown) or some other power source (also not shown) to operate the compressor. Additionally, such equipment and energy sources are not readily available at the remote location of a GPU 100 (FIG. 1). Thus, it is quite common to use pressurized natural gas 224 to run the heat trace pump 218, because there is a ready supply of pressurized natural gas at a GPU, either from the separator section 104 (FIG. 1), from the natural gas pipeline system 116 (FIG. 1) or a dehydrator (not shown in FIG. 1) and there is generally no readily available source of compressed air. Additionally, it may not be cost effective to provide a compressor and energy source for running the compressor in the field, when pressurized natural gas is readily available.

When using pressurized natural gas 224 to run a diaphragm pump such as heat trace pump 218, the pressurized natural gas 224 is injected in receiving end 226 of the heat trace pump 218 and then vented to the atmosphere via a vent line 230 from the exhaust port 228 of the heat trace pump 218. Again, a pressure regulator 222 may be used to condition the pressure of the natural gas 207 to a suitable pressure for operating the heat trace pump 218. For example and not by way of limitation, 80 psi natural gas from natural gas supply 206 may be regulated 222 to 30 psi pressurized natural gas 224.

It will be readily understood that the venting 230 of the natural gas from the heat trace pump 218 may be undesirable because it creates a dangerously flammable environment immediately around the heat trace pump 218 or the location of its vent to atmosphere 230. Furthermore, venting 230 wastes natural gas that could otherwise be used as fuel gas for running a burner system 202 or any other purpose. Simply venting 230 the natural gas exhaust from the heat trace pump 218 to atmosphere may have been cost effective when the cost of natural gas was sufficiently low. However, with the rising cost of fossil fuel energy sources such as natural gas it may no longer be cost effective to simply vent the natural gas into the atmosphere. Finally, with increased government regulation of the recovery of energy sources, venting natural gas may be prohibited for environmental air quality reasons. Thus, it would be highly advantageous to provide a natural gas recovery system and method to recapture or reduce the amount of natural gas that would otherwise be vented to atmosphere in a conventional GPU 100.

### SUMMARY OF THE INVENTION

The present invention is a method and system for recovering natural gas used to operate a diaphragm pump in a GPU at or near a natural gas well.

An embodiment of a natural gas recovery system is disclosed. The system includes a back pressure valve installed on a natural gas line between an exhaust port of heat trace diaphragm pump and a vent to atmosphere. The back pressure valve is configured for selectively blocking flow of natural gas to the vent. The system also includes a return line connected between the natural gas line and a burner system fuel line for redirecting the natural gas to a burner system.

Another embodiment of a natural gas recovery system may include a volume tank connected to an exhaust port of the heat trace diaphragm pump for receiving natural gas expelled from the exhaust port. The system further includes a back pressure valve on the vent line and a return line connected between the volume tank and burner system fuel line for redirecting the natural gas to a burner system.

An embodiment of a method of recovering natural gas expelled from a heat trace diaphragm pump exhaust port is also disclosed. The method may include preventing the natural gas from exhausting to atmosphere and redirecting the natural gas to a burner system.

Additional features and advantages of the invention will be set forth in the description which follows, and in part will be apparent from the description, or may be learned by the practice of the present invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG.1 is a simplified block diagram of conventional Gas Production Unit (GPU).

FIG. 2 is a simplified diagram of a conventional natural gas fuel system for use with a GPU.

FIG. 3 is a simplified diagram of a general embodiment of a natural gas recovery system according to the present invention as applied to the conventional natural gas fuel system illustrated in FIG. 2.

FIG. 4 is a diagram of a single burner, small volume tank embodiment of a natural gas recovery system, according to the present invention.

FIG. 5 is a diagram of a single burner, large volume tank embodiment of a natural gas recovery system, according to the present invention.

FIG. 6 is a diagram of a multiple burner, small volume tank embodiment of a natural gas recovery system, according to the present invention.

FIG. 7 is a flowchart of an embodiment of a method of recovering natural gas according to the present invention.

### DETAILED DESCRIPTION OF THE INVENTION

Various embodiments of a method and system for recovering natural gas are described in detail below. While the invention is particularly useful for reclaiming natural gas vented from diaphragm pumps used in GPUs near natural gas wells, it is not limited to such applications, but may be used for any conceivable application where it is desirable to recover gas exhausted from a diaphragm pump. The term “regulator” as used herein generally refers to a pressure regulator used to adjust the down-line pressure in natural gas pipelines and distribution systems. The term “line” as used herein generally refers to a pipeline used to transport natural gas (or other byproducts or resources such as oil or water) in a natural gas pipeline and/or natural gas distribution system. A line may be formed of any suitable tubing, generally comprising metal and of any suitable thickness and diameter, sufficient to deliver its intended payload, e.g., natural gas, oil or water.

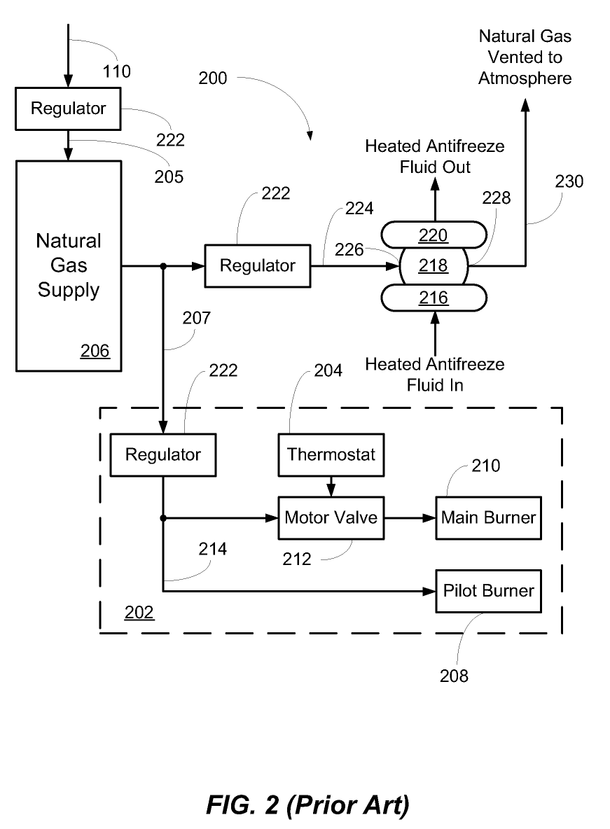

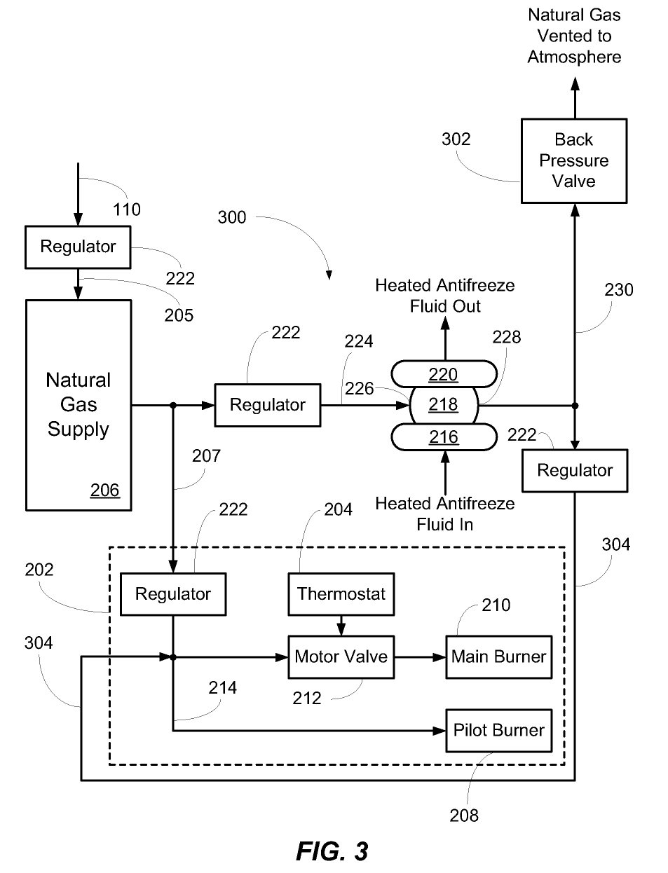

Referring now to FIG. 3, a simplified diagram of a general embodiment of a natural gas recovery system 300 of the present invention is shown as applied to the conventional natural gas fuel system 200 of FIG. 2. It will be understood that the essential modifications over the conventional system 200 are (1) installation of a back pressure valve 302 on vent line 230 and (2) redirecting the exhaust natural gas from vent line 230 through a pressure regulator 222 back into return line 304 where it can be used for any purpose including fueling the burner system 202 as shown in FIG. 3. The distinct advantage of system 300 over conventional system 200 is that the exhausted natural gas is not wasted by venting to atmosphere and can be reused. Another advantage of system 300 is that it will likely comport or comply with present or future regulations on venting of natural gas to the atmosphere as promulgated by government agencies that may regulate energy production companies to protect the environment.

As shown in FIG. 3, system 300 may include a high pressure natural gas line 110 feeding a regulator 222 before piping to natural gas supply 206. The natural gas supply 206 provides natural gas 207 to the heat trace pump 218 via a regulator 222. The natural gas supply 206 also provides natural gas 207 to burner system 202 as described above. Return line 304 may be biased to supply the burner system 202 in favor of the natural gas supply 206. But, it will be understood that natural gas supply 206 may always be in place to run the heat trace pump 218 and burner system 202, when the return line 304 does not supply natural gas, e.g., in warm weather.

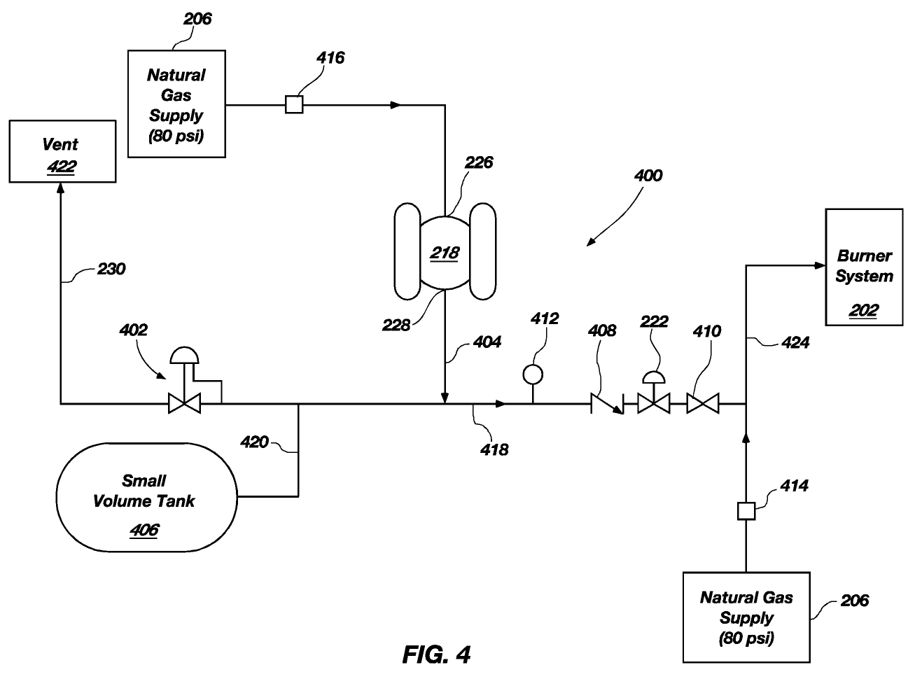

FIG. 4 is a diagram of an embodiment of a natural gas recovery system, shown generally at 400 according to the present invention. System 400 is a single burner embodiment with a small volume tank 406. System 400 may include a back pressure valve 402 connected to the natural gas line 404 exiting the exhaust port 228 of heat trace pump 218. The back pressure valve 402 maintains pressure on the natural gas line 404 at approximately 2 psi higher than the burner regulator 414 output pressure. Thus, natural gas expelled from the heat trace pump 218 exhaust port 228 is directed back to the burner system 202 for use as a fuel source.

Natural gas line 404 may also be connected to a small volume tank 406 via tank line 420 for storing natural gas expelled from the heat trace pump 218 exhaust port 228. Small volume tank 406 provides some buffering of the total volume of natural gas that can be stored in system 400. Back pressure valve 402 may also be connected to a vent line 230 which may in turn be connected to a vent 422 to allow for venting excess natural gas in system 400 to the atmosphere if necessary. However, the primary purpose of back pressure valve 402 is to prevent natural gas from being vented to atmosphere and to redirect the natural gas expelled from the heat trace pump 218 exhaust port 228 back along return line 418 to a burner system fuel line 424 for use as fuel for burner system 202.

System 400 may further include a check valve 408, pressure regulator 222 and shut-off valve 410 along the natural gas line 404 leading back to the burner system 202. Pressure regulator 222 and check valve 408 work in tandem to maintain the pressure of natural gas line 404 higher than the output pressure of burner regulator 414 and to prevent gas from natural gas supply 206 from entering into natural gas line 404. An optional pressure gauge 412 (located as shown) may be included on natural gas line 404 to monitor the pressure of natural gas along return line 418 or at other locations (not shown in FIG. 4) within system 400.

As shown in FIG. 4, a natural gas supply 206 and heat trace pump regulator 416 may be used to supply the pressurized gas to one end 226 of heat trace pump 218. The same natural gas supply 206 may also be tapped with a burner regulator 414 to supply properly pressurized natural gas to burner system 202 even in the absence of recovered natural gas from line 404.

According to another embodiment, a natural gas recovery system 400 may include a back pressure valve 402 installed on a natural gas line 404 between an exhaust port 228 of heat trace diaphragm pump 218 and a vent 422 to atmosphere. According to this embodiment of a natural gas recovery system 400, the back pressure valve 402 may be configured for selectively blocking flow of natural gas to the vent 422. Further according to this embodiment of a natural gas recovery system 400, a return line 418 may be connected between the natural gas line 404 and a burner system fuel line 424 for redirecting the natural gas to a burner system 202.

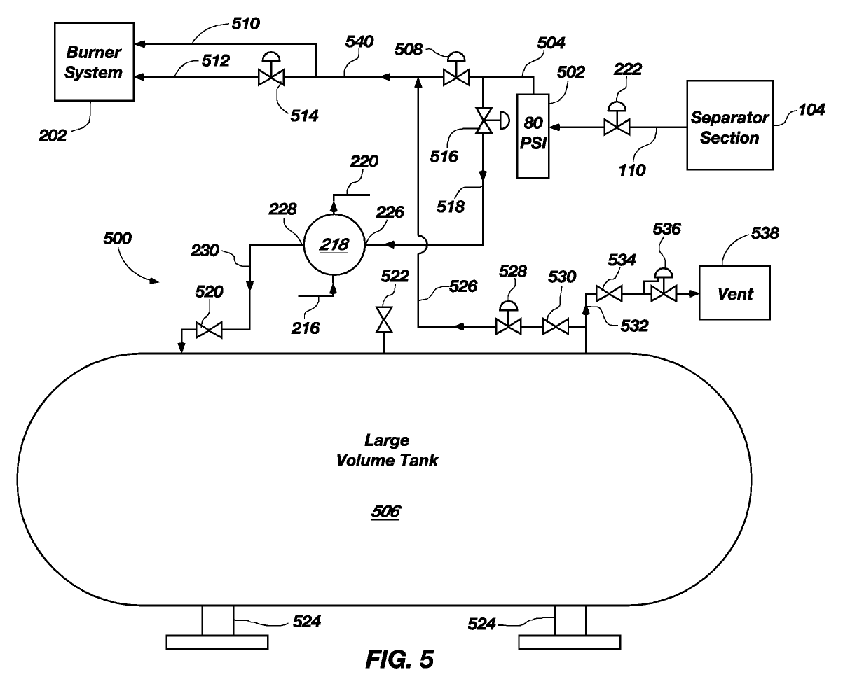

According to still another variation of this embodiment, natural gas recovery system 400 may further include a pressure regulator 222 on the return line 418 for selectively conditioning the pressure of the natural gas before it reaches the burner system fuel line 424. According to yet another variation of this embodiment, natural gas recovery system 400 may further include a shut-off valve 410 between the return line 418 and the burner system fuel line 424. According to still another variation of this embodiment, natural gas recovery system 400 may further include a check valve 408 on the return line 418. According to another variation of this embodiment, natural gas recovery system 400 may further include a pressure gauge 412 on the return line 418. According to a further variation of this embodiment, natural gas recovery system 400 may further include a volume tank 406 (or 506, see FIG. 5 and related discussion below) connected to the return line 418 configured for storing natural gas.

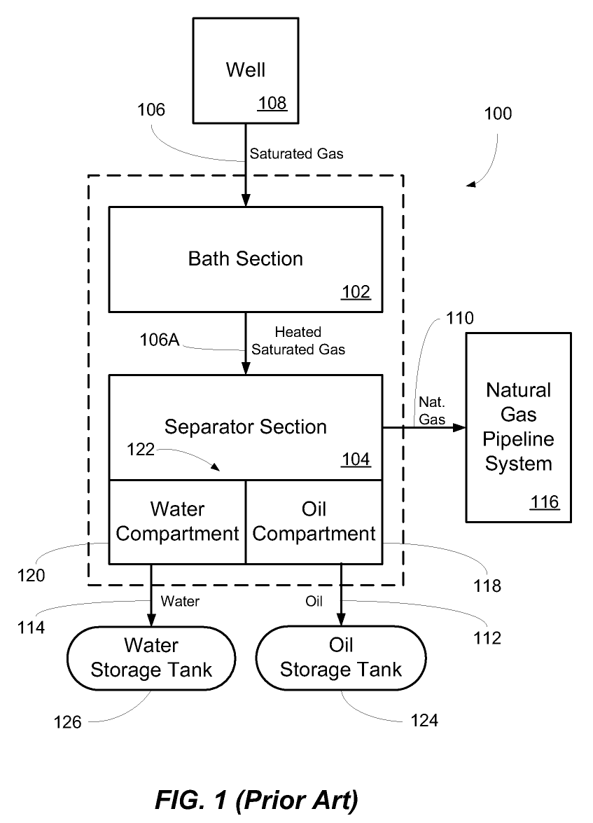

In operation, system 400 allows natural gas exiting heat trace pump 218 into natural gas line 404 to be redirected back into the burner system 202. It will be readily apparent to one of skill in the art that the natural gas line 404 could alternatively be redirected back into the natural gas supply 206 as pipeline grade natural gas, similar to the natural gas exiting separator section 104 (FIG. 1). When not in operation, shut-off valve 410 may be closed and the heat trace pump 218 turned off. Thus, according to one feature of system 400, natural gas that would otherwise be vented to atmosphere may be recovered and used again.

FIG. 5 is a diagram of another embodiment of a natural gas recovery system, shown generally at 500 according to the present invention. System 500 is a single burner embodiment with a large volume tank 506. System 500 may include natural gas 110 piped directly from the separator section 104 of a GPU 100 (FIG. 1). System 500 may further include a pressure regulator 222 leading to a fuel gas scrubber 502 which outputs pressurized natural gas 504. Fuel gas scrubber 502 may be configured to condition the natural gas to a selected pressure, for example as shown and not by way of limitation, 80 psi. System 500 may further include a burner regulator 508 for conditioning the pressurized natural gas 504 to a selected pressure, for example and not by way of limitation, 6 psi. The natural gas exiting burner regulator 508 may be directed along pilot gas line 510 and to main burner gas line 512 via main burner motor valve 514. According to one embodiment, the main burner motor valve 514 may comprise motor valve 212 and thermostat 204 as shown in FIG. 2.

Pressurized natural gas 504 coming from the fuel gas scrubber 502 may also be directed to pump regulator 516 for conditioning the pressure of the natural gas in the pump supply gas line 518 for powering heat trace pump 218 at receiving end 226. Heat trace pump 218 inlet port 216 and outlet port 220 form the suction and discharge portions, respectively, of the diaphragm pump action used to pump antifreeze fluid. Vent line 230 may be piped to large volume tank 506 with an intervening optional valve 520. According to another embodiment, large volume tank 506 may be equipped with a drain valve 522 for draining the contents of large volume tank 506. Large volume tank 506 may have one or more structural members 524 (two shown in FIG. 5) for surface mounting and secure placement of the large volume tank 506 as the particular application may demand. The use of a large volume tank 506 allows significant storage of natural gas expelled from heat trace pump 218, within system 500.

Natural gas stored in large volume tank 506 may be directed along return line 526 to the burner system at pilot gas line 510 and main burner gas line 512. Return line 526 may include a valve 530, according to one embodiment. According to another embodiment, return line 526 may include a return line regulator 528 for conditioning the pressure of the natural gas delivered to the burner system along return line 526. For example and not by way of limitation, return line regulator 528 may be configured to output natural gas at 8 psi. The particular pressure of natural gas output by return line regulator 528 may be selected to bias the natural gas burned by the burner system to be sourced largely from large volume tank 506 rather than natural gas from the fuel gas scrubber 502. Of course, output pressure of the return line regulator 528 may be adjusted for other conditions and preferences as the application may demand.

Natural gas stored in large volume tank 506 may also be directed along vent line 532 to vent 538 where necessary. Vent line 532 may include valve 534 and back pressure valve 536. Back pressure valve 536 may be set to 12 psi, for example, to bias natural gas into the return line 526 rather than along the vent line 532 to the vent 538.

According to another embodiment, a natural gas recovery system 500 may include a volume tank 506 (or 406, FIG. 4) connected to an exhaust port 228 of heat trace diaphragm pump 218 for receiving natural gas expelled from the exhaust port 228. According to another embodiment, natural gas recovery system 500 may further include a return line 526 connected between the volume tank 506 (or 406, FIG. 4) and a burner system fuel line 540 for redirecting the natural gas to a burner system 202. According to yet another embodiment, natural gas recovery system 500 may further include a pressure regulator 528 on the return line 526 for selectively conditioning the pressure of the natural gas before it reaches the burner system fuel line 540. According to still another embodiment, natural gas recovery system 500 may further include a vent line 532 connected to the return line for venting natural gas to atmosphere. According to still another embodiment, natural gas recovery system 500 may further include a back pressure valve 536 on the vent line 532 between the return line 526 and a vent 538 to atmosphere. According to another embodiment, natural gas recovery system 500 may further include a valve 534 on the vent line 532 configured for selectively blocking passage of natural gas therethrough.

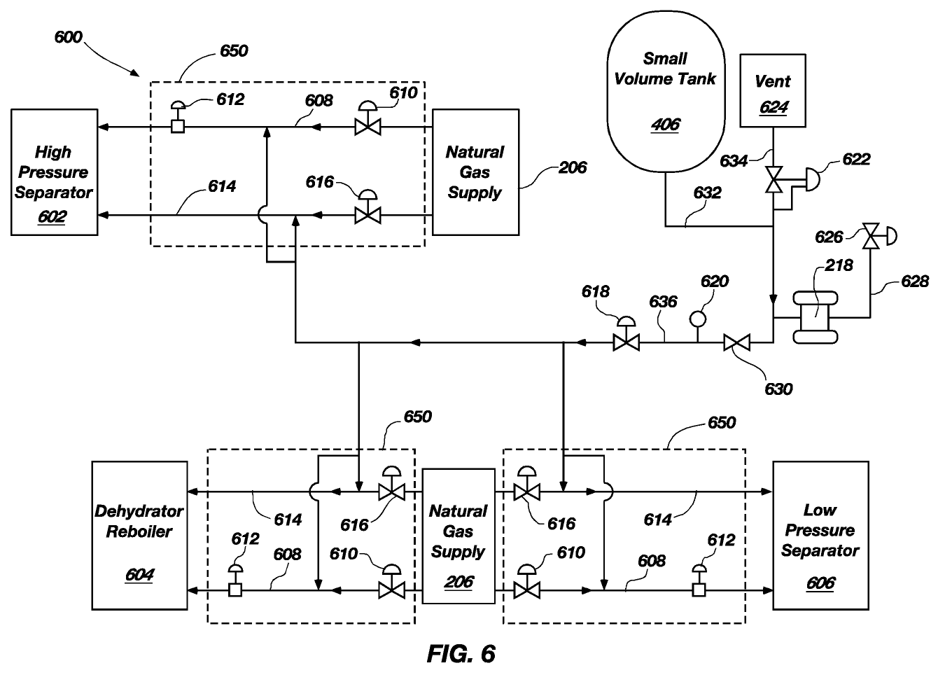

It will be understood that the single burners illustrated in FIGS. 3-5 are only exemplary and that there are no limitations of the number of burners that may be fueled by the natural gas recovery systems 300, 400 and 500 illustrated herein. Burners may be used for various tasks in GPUs (FIG. 1), e.g., heating saturated gas (106A, FIG. 1) and heating dump lines (112 and 114 in FIG. 1) as already described. Burners may find additional applications in GPUs. For example and not by way of limitation, burners may be needed in high and low pressure sections of a separator (not shown in FIGS. 1-5, but see 602 and 606 in FIG. 6 and related discussion below). Burners may also find application in a dehydrator reboiler (also not shown in FIGS. 1-5, but see 604 in FIG. 6 and related discussion below).

FIG. 6 illustrates a multiple burner embodiment of a natural gas recovery system for use in a GPU (FIG. 1), shown generally at 600. Natural gas from a natural gas supply (not shown) may be pressure regulated through pump regulator 626 to operate heat trace pump 218. Natural gas exhausted from the heat trace pump 218 may be recovered as a burner fuel according to system 600 disclosed herein. System 600 may include multiple burner systems 650 (three shown in dotted lines). For example and not by way of limitation, the burner systems 650 may individually be used for heating in a high pressure separator 602, a dehydrator reboiler 604 and a low pressure separator 606. Each of the three burner systems 650 may be fueled by a natural gas supply 206. Natural gas supply 206 provides a source of pressurized natural gas, for example 80 psi, to each burner system 650. Each burner system 650 may include a main burner line 608 with a main burner regulator 610 feeding a main burner motor valve 612. Each burner system 650 may further include a separate pilot gas line 614 with its own pilot gas regulator 616. The regulated main burner line 608 and pilot gas line 614 may provide natural gas to any section of a GPU that needs burner gas, for example as shown in FIG. 6, a high pressure separator 602, a dehydrator reboiler 604 or a low pressure separator 606. Natural gas supply 206 provides a steady source of pressurized natural gas to fuel burner systems 650.

System 600 may further include a return line 636 for receiving natural gas exhausted by heat trace pump 218. Return line 636 may be routed to the main burner line 608 and pilot gas line 614 of each burner system 650 to supplement or supplant the fuel otherwise sourced by natural gas supply 206. Return line 636 may include a main regulator 618 for conditioning the pressure of the natural gas down-line. Return line 636 may further include an optional shut-off valve 630 selectively placed for turning off the return line 636. Return line 636 may further include an optional pressure gauge 620 for selective placement along the return line 636 (shown between main regulator 618 and shut-off valve 630 in FIG. 6).

Return line 636 may further include an optional small volume tank 406 tapping return line 636 via tank line 632. The optional small volume tank 406 may be used to buffer the amount of natural gas that may be recovered and stored in system 600 for use in fueling burner systems 650. Return line 636 may further include an optional vent line 634 tapped into return line 636 leading to a back pressure valve 622 and down-line to a vent 624. The optional vent line 634 and vent 624 may be used to vent excess natural gas from system 600 where necessary, for example where too much natural gas is in system 600. According to other embodiments of system 600, return line 636 may redirect the natural gas to multiple burner systems 650 (three shown in FIG. 6).

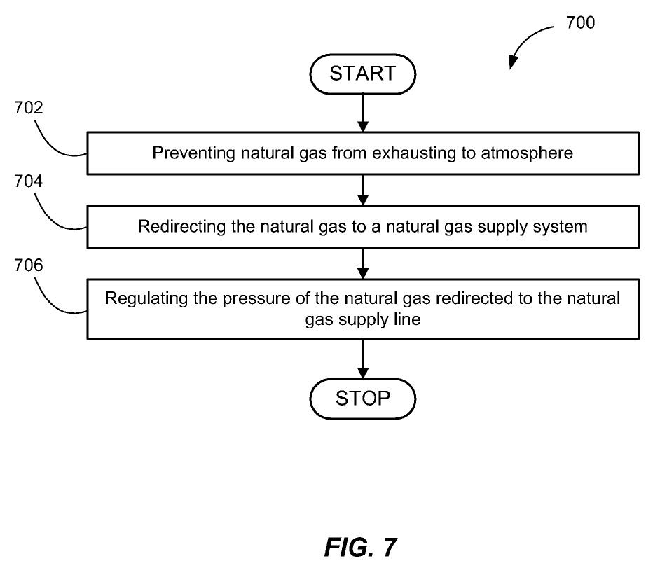

FIG. 7 is a flowchart of an embodiment of a method 700 of recovering natural gas expelled from a heat trace diaphragm pump (see, e.g., 218 of FIG. 3) exhaust port (see, e.g., 228 of FIG. 3), according to the present invention. Method 700 may include preventing 702 the natural gas from exhausting to atmosphere. Preventing 702 the natural gas from exhausting to atmosphere may be achieved by installing a back pressure valve (see, e.g., 402 of FIG. 4) along a vent line (see, e.g., 230 of FIG. 4) to selectively prevent the natural gas from exiting a vent (see, e.g., 422 of FIG. 4), according to one embodiment of the present invention. Method 700 may further include redirecting 704 the natural gas to a natural gas supply system (see, e.g., 206 of FIG. 4). Method 700 may further include regulating 706 the pressure of the natural gas redirected to the natural gas supply line.

Redirecting 704 the natural gas to the natural gas supply system may be achieved by connecting a return line from the heat trace diaphragm pump exhaust port to a burner system fuel line, according to another embodiment of the present invention. Redirecting 704 the natural gas to the natural gas supply system may be achieved by connecting a return line from the heat trace diaphragm pump exhaust port to the natural gas supply system, according to yet another embodiment of the present invention. Redirecting 704 the natural gas to the natural gas supply system may include connecting an exhaust return line from the heat trace diaphragm pump exhaust port to a volume tank and connecting a return line from the volume tank to a burner system fuel line, according to yet another embodiment of the present invention. According to still another embodiment, redirecting 704 the natural gas to the natural gas supply system may include connecting an exhaust return line from the heat trace diaphragm pump exhaust port to a volume tank and connecting a return line from the volume tank to the natural gas supply line.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A natural gas recovery system, comprising:
a back pressure valve installed on a natural gas line between an exhaust port of heat trace diaphragm pump and a vent to atmosphere, the back pressure valve configured for selectively blocking flow of natural gas to the vent; and
a return line connected between the natural gas line and a burner system fuel line for redirecting the natural gas to a burner system.

2. The natural gas recovery system according to claim 1, further comprising a pressure regulator on the return line for selectively conditioning the pressure of the natural gas before it reaches the burner system fuel line.

3. The natural gas recovery system according to claim 1, further comprising a shut-off valve between the return line and the burner system fuel line.

4. The natural gas recovery system according to claim 1, further comprising a check valve on the return line.

5. The natural gas recovery system according to claim 1, further comprising a pressure gauge on the return line.

6. The natural gas recovery system according to claim 1, further comprising a volume tank connected to the return line and configured for storing natural gas.

7. The natural gas recovery system according to claim 1, wherein the return line redirects the natural gas to multiple burner systems.

8. A natural gas recovery system, comprising:
a volume tank connected to an exhaust port of heat trace diaphragm pump for receiving natural gas expelled from the exhaust port; and
a return line connected between the volume tank and a burner system fuel line for redirecting the natural gas to a burner system.

9. The natural gas recovery system according to claim 8, further comprising a pressure regulator on the return line for selectively conditioning the pressure of the natural gas before it reaches the burner system fuel line.

10. The natural gas recovery system according to claim 8, further comprising a vent line connected to the return line for venting natural gas to atmosphere.

11. The natural gas recovery system according to claim 10, further comprising a back pressure valve on the vent line between the return line and a vent to atmosphere.

12. The natural gas recovery system according to claim 10, further comprising a valve on the vent line configured for selectively blocking passage of natural gas therethrough.

13. A method of recovering natural gas expelled from a heat trace diaphragm pump exhaust port, comprising:
preventing the natural gas from exhausting to atmosphere; and
redirecting the natural gas to a natural gas supply system.

14. The method according to claim 13, further comprising regulating the natural gas redirected to the natural gas supply system.

15. The method according to claim 13, wherein preventing the natural gas from exhausting to atmosphere comprises installing a back pressure valve along a vent line to selectively prevent the natural gas from exiting a vent.

16. The method according to claim 13, wherein redirecting the natural gas to the natural gas supply system comprises connecting a return line from the heat trace diaphragm pump exhaust port to a burner system fuel line.

17. The method according to claim 13, wherein redirecting the natural gas to the natural gas supply system comprises connecting a return line from the heat trace diaphragm pump exhaust port to the natural gas supply system.

18. The method according to claim 13, wherein redirecting the natural gas to the natural gas supply system comprises:
connecting an exhaust return line from the heat trace diaphragm pump exhaust port to a volume tank; and
connecting a return line from the volume tank to a burner system fuel line.

19. The method according to claim 13, wherein redirecting the natural gas to the natural gas supply system comprises:
connecting an exhaust return line from the heat trace diaphragm pump exhaust port to a volume tank; and
connecting a return line from the volume tank to the natural gas supply line.

20. The method according to claim 19, further comprising regulating the pressure of the natural gas redirected to the natural gas supply line.
